(19) United States
(12) Patent Application Publication
(10) Pub. No.: US 2005/0059378 A1
(43) Pub. Date: Mar. 17, 2005

(54) Capturing multimedia signals

(76) Inventor: Taek Sung Kim, Syosset, NY (US)

Correspondence Address: SAMUEL S. LEE, P.O. BOX 927959, SAN DIEGO, CA, 92192-7959, US

(21) Appl. No.: 10/803,656

(22) Filed: Mar. 17, 2004

Related U.S. Application Data
(63) Continuation-in-part of application No. 10/661,732, filed on Sep. 12, 2003.

(51) Int. Cl. G06F 7/00

(52) U.S. Cl. 455/352

(57) ABSTRACT

A media contents capturing system for capturing media contents from a display of a multimedia player, The media contents capturing system includes a display area selection element, a transceiver, and a processor. The display area selection element selects an area of the display. The transceiver is in communication with the multimedia player to provide data commands for receiving media contents data of the area of display. The processor is configured to send and receive data commands and media contents data from said transceiver.

### CROSS-REFERENCE TO RELATED APPLICATIONS

This application is a continuation-in-part application of co-pending U.S. patent application Ser. No. 10/661,732, entitled “Remote Control Device Capable of Sensing Motion”, filed Sep. 12, 2003. Benefit of priority of the filing date of Sep. 12, 2003 is hereby claimed for common material, and the disclosure of the U.S. Patent Application is hereby incorporated by reference.

### BACKGROUND

The present disclosure generally relates to media contents, and more specifically, to capturing video and/or audio signals from a portion of a visual display.

Capturing and/or recording multimedia contents, such as images, videos, and audios, shown on a multimedia player (e.g., a television or computer screen) has been made possible through the use of video recorders such as VCRs and DVD recorders. The recordings can be made from the multimedia player screen regardless of the source of the video and audio. However, these prior art methods of capturing and/or recording present problems, including having to program the recording device for a particular channel and a particular time. Some of these problems can be obviated by performing the recording real-time while the desired program is being shown on the screen. Attempts that have been made to provide solutions to these problems include providing a programmable multimedia player having relatively easy programming process.

Further, currently-available multimedia players provide multiple input sources that can be shown on the screen simultaneously. For example, a viewer can be viewing a football game on the main screen while the small insert screen is showing a favorite soap opera. In this case, the viewer may want to record the entire or a portion of the soap opera. In another example, the main screen shows a video where the viewer may want to capture or record a portion of the screen showing an image or video of interest.

However, none of the above-described configurations of multimedia players and video recorders provide easy solutions for performing the above-described tasks.

### SUMMARY

A media contents capturing system for capturing media contents from a display of a multimedia player, The media contents capturing system includes a display area selection element, a transceiver, and a processor. The display area selection element selects an area of the display. The transceiver is in communication with the multimedia player to provide data commands for receiving media contents data of the area of display. The processor is configured to send and receive data commands and media contents data from said transceiver.

### BRIEF DESCRIPTION OF THE DRAWINGS

Different aspects of the disclosure will be described in reference to the accompanying drawings.

FIG. 1A shows a perspective view of a remote control device performing a yaw motion.

FIG. 1B illustrates the horizontal movement of a cursor on a computer screen in response to the yaw motion of the remote control device.

FIG. 2A shows a perspective view of a remote control device performing a horizontal translation motion.

FIG. 2B illustrates the horizontal movement of a cursor on a computer screen in response to the horizontal translation motion of the remote control device.

FIG. 3A shows a perspective view of a remote control device performing a pitch motion.

FIG. 3B illustrates the vertical movement of a cursor on a computer screen in response to the pitch motion of the remote control device.

FIG. 3C shows a side view of the remote control device illustrating the pitch motion.

FIG. 4A shows a perspective view of a remote control device performing a vertical translation motion.

FIG. 4B illustrates the vertical movement of a cursor on a computer screen in response to the vertical translation motion.

FIG. 4C shows a side view of the remote control device illustrating the vertical translation motion.

FIG. 5 shows a front view of an exemplary remote control device according to an embodiment of the present invention.

FIG. 6 is a block diagram of a remote control device according to an embodiment of the present invention.

FIG. 7 illustrates a configuration of position sensors as a pair of antennas and a differential GPS in accordance with an embodiment of the present invention.

FIG. 8 illustrates a media content capturing system in accordance with one implementation of the present invention.

FIG. 9 illustrates another configuration of the display screen in which the selected area is one of several preview screens.

FIG. 10 illustrates yet another configuration of the display screen in which the selected area is a portion of the display screen.

FIG. 11 illustrates a further configuration of the display screen in which the selected area encompasses the entire display screen.

### DETAILED DESCRIPTION

To meet the need for an enhanced method of capturing and/or recording multimedia contents without the above-described difficulties of the conventional method, exemplary embodiments are described for system and method of capturing multimedia contents using a motion-sensible remote control device. The structure and steps for capturing multimedia contents will be described after the motion-sensible remote control device has been described.

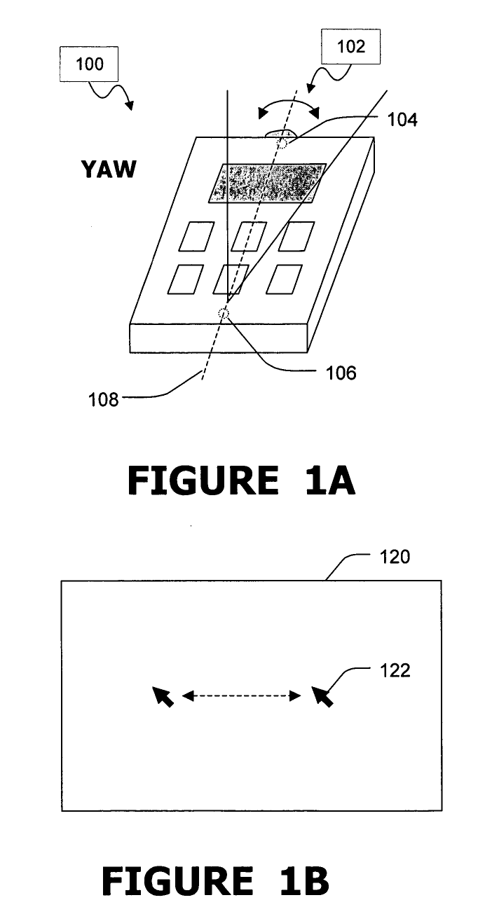

FIG. 1A shows a perspective view of a remote control device 100 in accordance with an embodiment of the present invention. In the illustrated embodiment of FIG. 1A, the remote control device 100 is shown in a configuration in which the device makes a “yaw” movement 102. The “yaw” movement 102 is defined in this specification as a horizontal angular movement of a point 104 on the remote control device 100 with respect to another point 106 on the remote control device. The horizontal plane on which the angular movement is measured is defined as a terrestrial horizontal plane. For typical remote control purposes, the terrestrial horizontal plane is substantially parallel with “horizon” or a flat surface on earth. Thus, the yaw movement 102 will move a cursor 122 horizontally on the screen 120 (that is placed “level” on a flat surface) as shown in FIG. 1B. The amount or distance of the cursor movement depends on the angle of the yaw movement 102.

To be compatible with the conventional definition of “yaw” used for aircraft motion, the point 104 should be in front of the point 106 with respect to the perspective of the user, who is present behind the point 106. Thus, a line from the point 106 to the point 104 will typically be pointing toward the screen 120. However, the direction will be reversed in an unusual situation when the user's back is facing the screen 120.

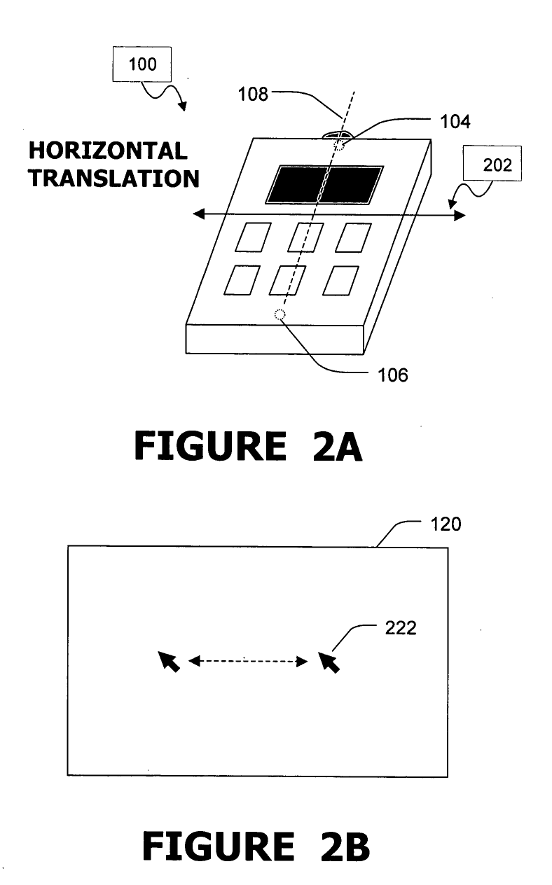

FIG. 2A shows another configuration in which the remote control device 100 makes a horizontal translation movement 202. The horizontal translation movement 202 is defined in this specification as a horizontal movement of a line 108 connecting the point 104 with the point 106 with respect to the terrestrial horizontal plane. Thus, the horizontal translation movement 202 will move a cursor 222 horizontally on the screen 120 as shown in FIG. 2B. The amount or distance of the cursor movement depends on the distance or length of the translation movement 202.

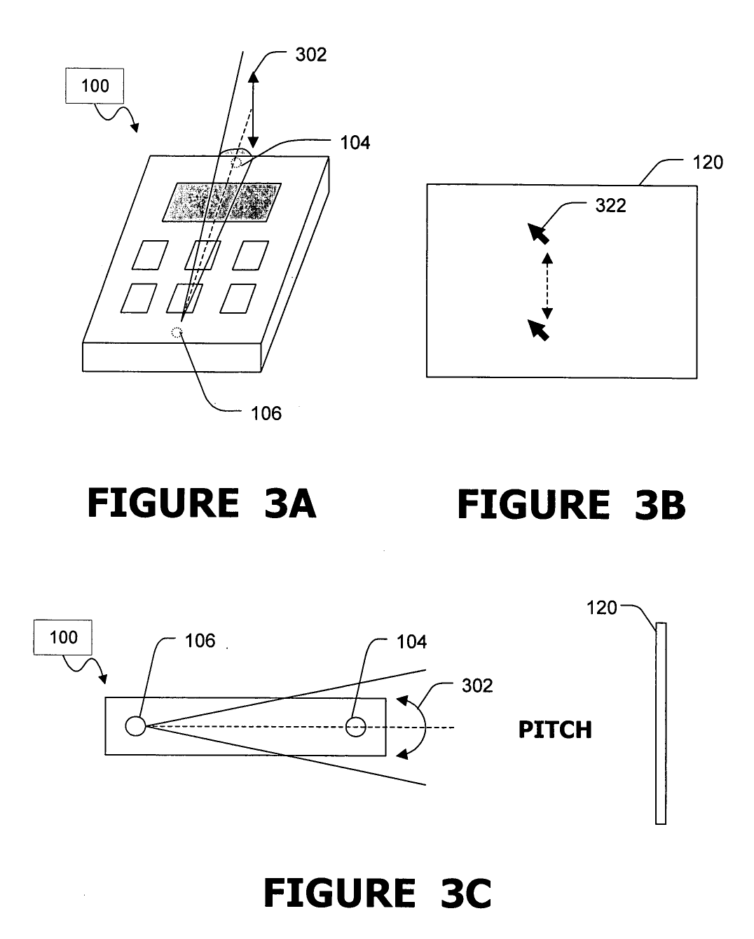

FIG. 3A shows another configuration of the remote control device 100 in which the device makes a “pitch” movement 302. The “pitch” movement 302 is defined in this specification as a vertical angular movement of the point 104 with respect to the point 106 on the remote control device. Again, the vertical angular movement is measured with respect to the terrestrial horizontal plane. Thus, the pitch movement 302 will move a cursor 322 vertically on the screen 120 as shown in FIG. 3B.

FIG. 3C shows a side view of the remote control device 100 illustrating the pitch movement 302. The amount or distance of the vertical cursor movement depends on the angle of the pitch movement 302.

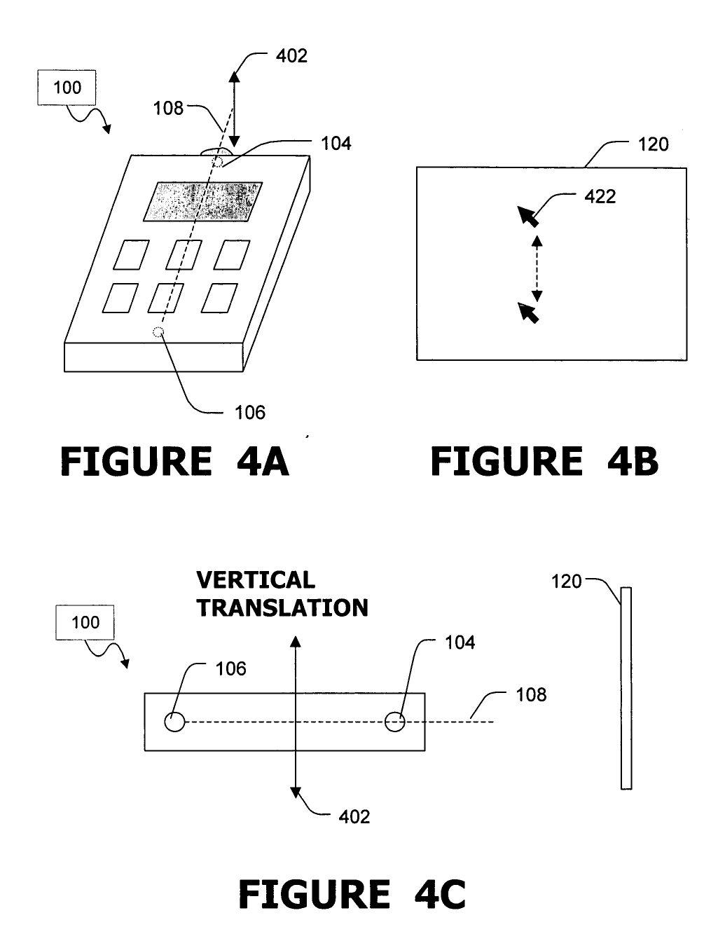

FIG. 4A shows another configuration in which the remote control device 100 makes a vertical translation movement 402. The vertical translation movement 202 is defined in this specification as a vertical movement of the line 108 connecting the point 104 with the point 106. The vertical movement is defined as a movement along a plane that is perpendicular to the terrestrial horizontal plane. Thus, the vertical translation movement 402 will move a cursor 422 vertically on the screen 120 as shown in FIG. 4B. The amount or distance of the cursor movement depends on the distance or length of the vertical translation movement 402. FIG. 4C shows a side view of the remote control device 100 illustrating the vertical translation movement 402.

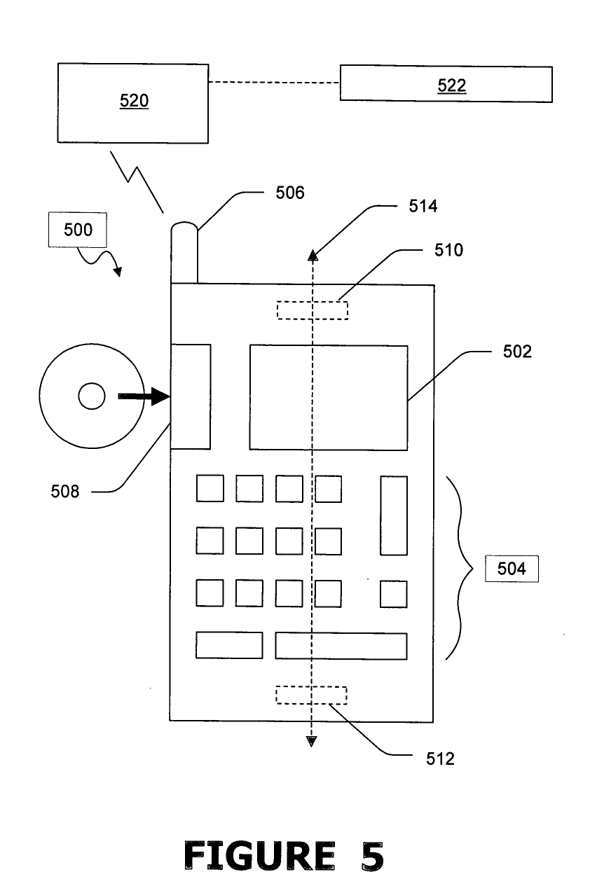

FIG. 5 shows a front view of an exemplary remote control device 500 according to an embodiment of the present invention. FIG. 5 also illustrates a block diagram of an external device 520 and a screen 522 that interfaces with the external device. In one embodiment, the external device 520 is a computer. In another embodiment, the external device is a television. The remote control device 500 is used to control a graphical icon or cursor on the screen 522. The remote control device 500 can be used to control displays for electronic devices other than a computer or television.

In the illustrated embodiment of FIG. 5, the remote control device 500 includes a local display 502 and various function keys and buttons 504. The remote control device 500 also includes an antenna 506, which is used to transmit or receive radio frequency signals to and from the external device 520. The remote control device 500 may also include a CD or disk drive 508. In illustrated embodiment, the drive 508 is a CD ROM drive.

The exemplary remote control device 500 also includes a pair of position sensors 510, 512, which are operatively configured so that the sensors 510, 512 can sense the motions (i.e., yaw, pitch, horizontal translation, and vertical translation motions) of an imaginary line 514, as described above. The motions of the line 514 are measured with respect to the terrestrial horizontal plane. Thus, various motions of the remote control device 500 are visually fed back to a user by the graphical icon or cursor displayed on the screen 522. Movement of a cursor on the screen 522 copies the motions of the remote control device 500. Thus, yaw, pitch, horizontal translation, and vertical translation motions are combined and processed to produce a resultant movement of the cursor on the screen 522, which is level positioned on a flat surface of the earth. If the screen 522 is positioned at an angle rather than level on a flat surface, then this information should be entered into the remote control device 500 to account for the tilt and appropriately offset the movement of the cursor. The processor 502 can appropriately calculate the offset of the cursor movement.

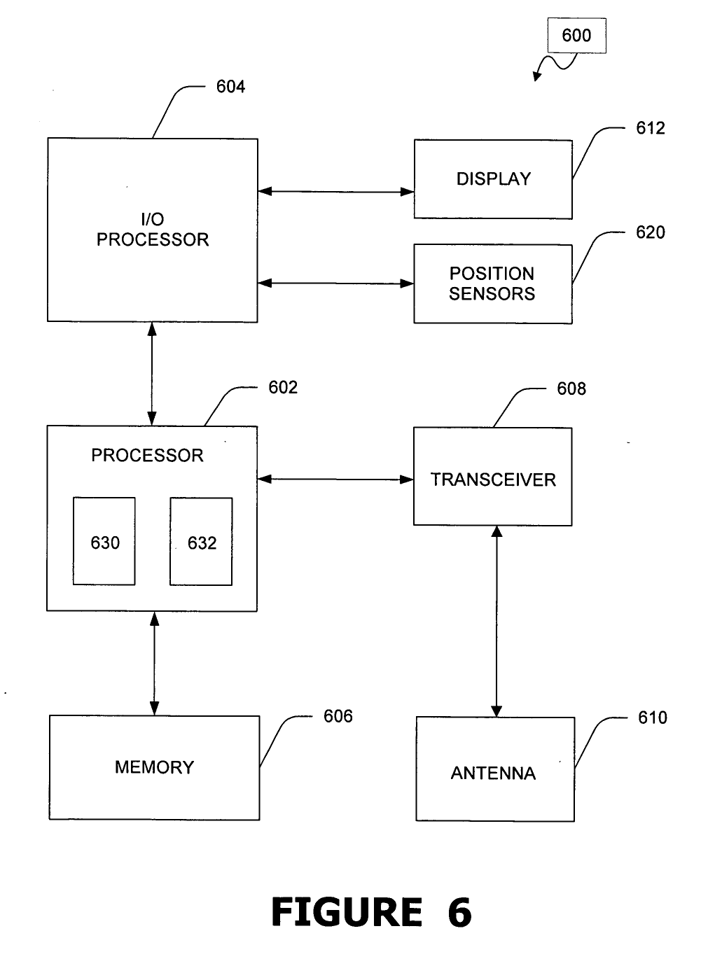

A block diagram of a remote control device 600 according to an embodiment of the present invention is shown in FIG. 6. The remote control device 600 comprises a main processor 602 and at least first and second sensors 620. The sensors 620 are operatively configured to provide position information of at least first and second positions, such as 104 and 106 on the remote control device 100 in FIG. 1A through FIG. 4A. The position information provided by the sensors 620 should be sufficiently accurate to distinguish the first position (e.g., position 104) from the second position (e.g., position 106), such that the provided position information of the first position with respect to the second position provides enough information to the processor 602 to determine yaw, pitch, horizontal and vertical translation motions of the remote control device.

In the illustrated embodiment of FIG. 6, the main processor 602 interfaces with an I/O processor 604 and a memory 606. The I/O processor 604 processes and controls a local display 612 and the sensors 620. The local display 612 can be used to display local information such as estimated motions of the remote control device with respect to the terrestrial plane and the resultant cursor movement. The display 612 can also show information such as cursor offset, position information of the remote control device, and other related information.

The main processor 602 receives the position information of the first and second positions. The main processor 602 includes a motion converter 630 that processes the position information to determine angle and distance of the yaw, pitch, horizontal and vertical translation motions. The processor 602 also includes a cursor movement converter 632 which converts these motions into an amount of cursor movement on the main screen. The main processor 602 interfaces with external devices (e.g., a computer 520 shown in FIG. 5) through a transceiver 608 and an antenna 610. Thus, the amount of cursor movement is transmitted to an external device through the transceiver 608. The transceiver 608 also receives commands and messages from the external device. In some embodiments, the main processor 602 and the I/O processor 604 may be configured as one processor performing both functions.

In the illustrated embodiment of FIG. 6, the sensors 620 are configured as position sensors rather than as attitude sensors, such as a gyroscope, for sensing the motions of the remote control device 600 because position sensors are cheaper and easier to maintain than the attitude sensors. However, the use of position sensors 620 requires the sensors to be sufficiently accurate so that the movement of at least two points on the remote control device with respect to the terrestrial horizontal plane can be ascertained.

For example, a typical conventional remote control device that controls electronic devices, such as a television, may be about 15 to 20 centimeters long and about 4 to 6 centimeters wide. If the dimensions of the remote control device 500 shown in FIG. 5 is assumed to be approximately similar to the conventional remote control device, and it is assumed that the sensors would be placed longitudinally at the ends of the remote control device 500, then the accuracy of the sensors 620 should be within about 5 to 7 centimeters in order to sufficiently accurately determine the movement of the line between the two points with respect to the terrestrial horizontal plane.

With the advent of Global Positioning System (GPS), terrestrial navigation has been made possible with position accuracy in the range of about one to two meters. This still is not sufficient to distinguish the positions of points within a remote control device, whose dimensions are as described above. The main source of errors that contribute to degradation of GPS accuracy to this range is the timing errors. Accordingly, if the timing errors can be sufficiently corrected, the position accuracy of the GPS measurement would improve significantly. A concept referred to as “differential GPS” has been used to improve the GPS accuracy by significantly reducing the timing errors. Accordingly, it was realized that the use of a differential GPS receiver with antennas strategically placed on the remote control device can provide terrestrial positions with sufficient accuracy (i.e., within about 5 to 7 centimeters) to enable motion sensing within the remote control device.

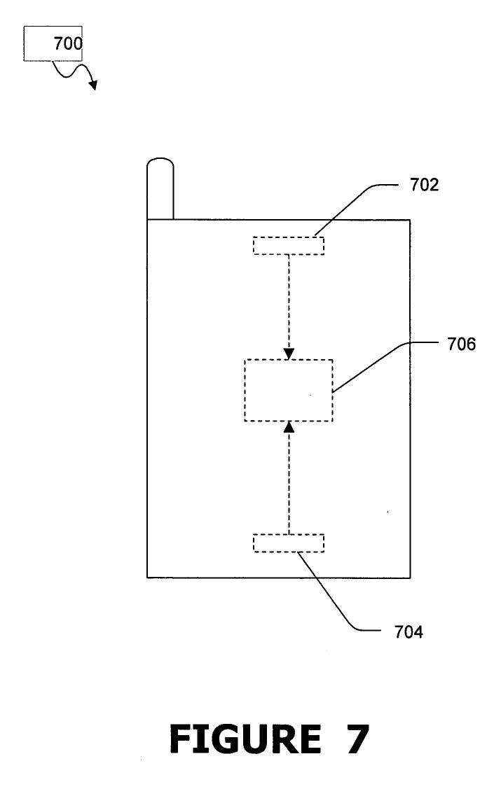

FIG. 7 illustrates a configuration of position sensors as a pair of antennas and a differential GPS in accordance with an embodiment of the present invention. Various function keys and buttons have been omitted for clarity.

In the illustrated embodiment of FIG. 7, the remote control device 700 includes sensors, which are configured as a pair of antennas 702, 704 and a differential GPS receiver 706. The antenna 702 provides received GPS signal at a position where the antenna 702 is located. Likewise, the antenna 704 provides received GPS signal at a position where the antenna 704 is located. The differential GPS receiver 706 receives the signals from the two antennas 702, 704, along with corrections necessary to substantially reduce the timing errors. In an alternative embodiment, the sensors can be configured as a plurality of antennas and a corresponding plurality of differential GPS receivers.

In one embodiment, the corrections can be received from a source through a transceiver on the remote control device. The source may be an Internet site that provides the corrections when the approximate location of the remote control device is entered. In another embodiment, the corrections can be locally broadcast to the transceiver. In a further embodiment, the corrections can be calculated by the differential GPS receiver 706 by providing sufficiently accurate position information of the relatively stationary remote control device 700.

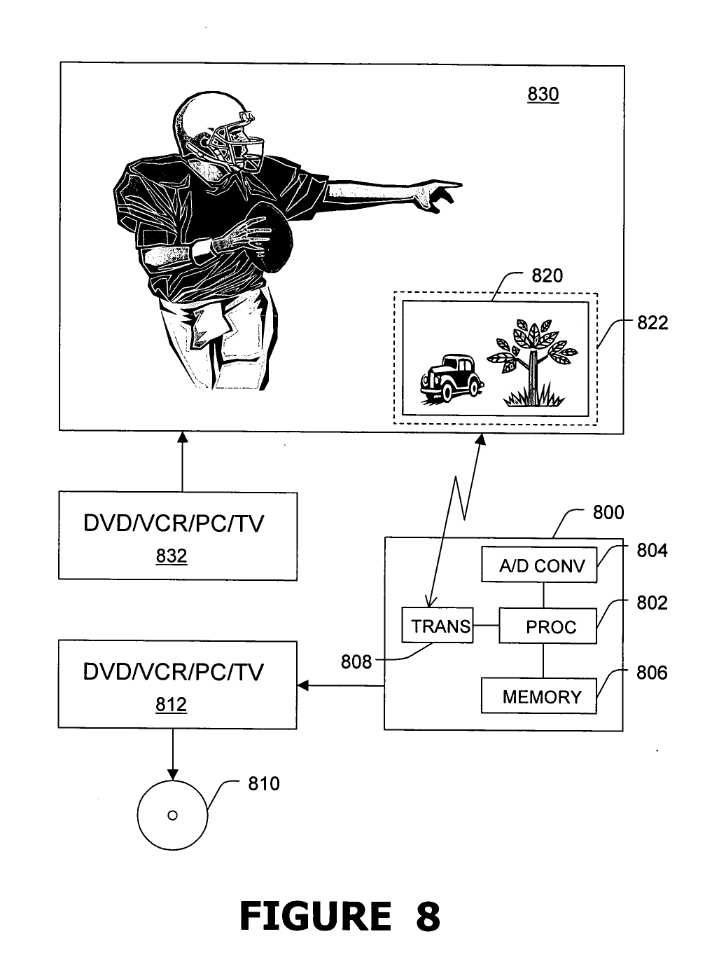

FIG. 8 illustrates a media content capturing system 800 in accordance with one implementation of the present invention. In the illustrated embodiment of FIG. 8, the capturing system 800 selects to capture media contents of an insert screen 820. The capturing system 800 includes a processor 802, an A-to-D converter 804, a memory 806, and a transceiver 808.

In one embodiment, the capturing system 800 may also include a remote controller, such as the motion-sensible remote control device 600, to select the insert screen 820. In other embodiments, the capturing system 800 can interface with a display area selection apparatus (not shown) to select an area 822 of the display screen 830.

Once the area 822 to be captured has been selected, the processor 804 in the capturing system 800 communicates with the multimedia player 832 that is controlling the display screen 830. The communication may include information that the area 822 to be captured is an insert screen 822, and the commands from the capturing system 800 to the multimedia player 832 to transmit the media contents data of the selected area 822. The communication may be done using a wired connection or a wireless connection.

The media contents data can be analog or digital data depending on the type of media contents being displayed on the display screen 830. When the screen 830 is displaying a DVD or HDTV output, the media contents data may be digital. When the screen 830 is displaying an NTSC-formatted TV or cable output, the media contents data may be analog. Thus, when the received media contents data is analog, the data can be converted into digital data by the A-to-D converter 804 before being processed and stored/recorded onto a recordable media 810 using the multimedia player 812. In other implementations, the processed media contents data can be displayed on a multimedia player without being stored.

In another embodiment, the downloading of the selected media contents data can be done optically. For example, when the selected media contents data is a television signal, the capturing system 800 has to interface with a relatively “dumb” multimedia player 832, such as the television. In this case, the optical method of capturing the area 822 of the display screen 830 may provide an optimal solution.

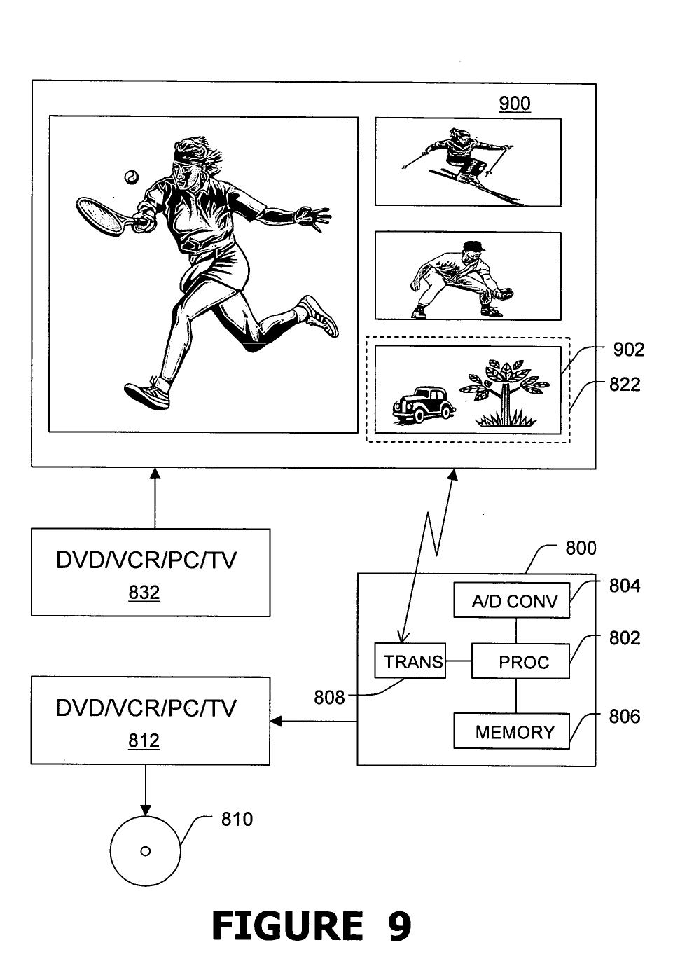

FIG. 9 illustrates another configuration of the display screen 900. In this configuration, the selected area 902 is one of several preview screens.

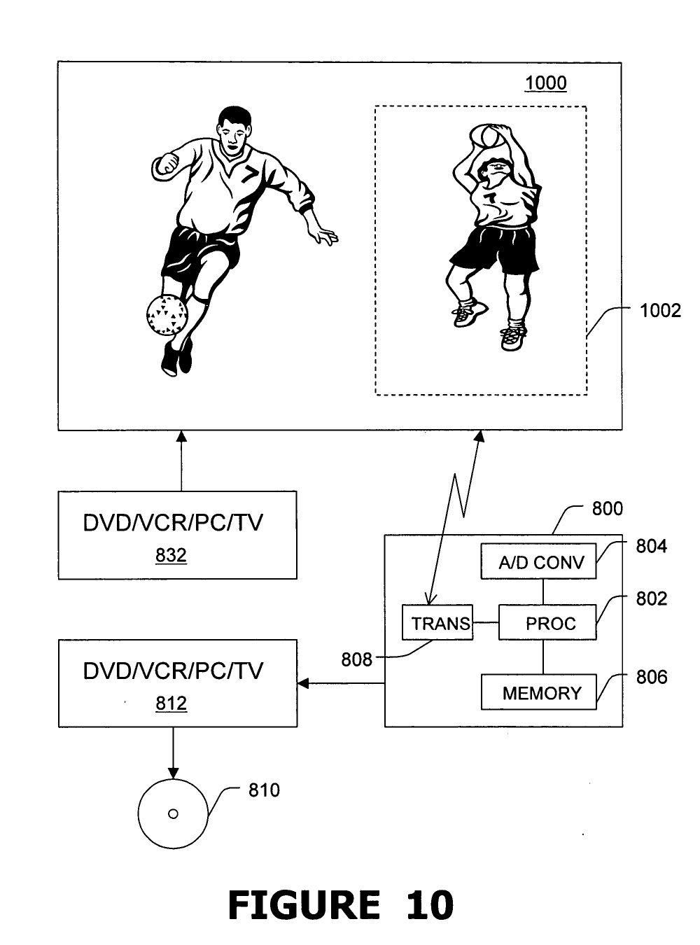

FIG. 10 illustrates yet another configuration of the display screen 1000 in which the selected area 1002 is a portion of the display screen 1000. In this configuration, the capturing system 800 must transmit the coordinates of the selected area 1002 with respect to the display screen to the multimedia player 832 to receive the multimedia contents data from the multimedia player.

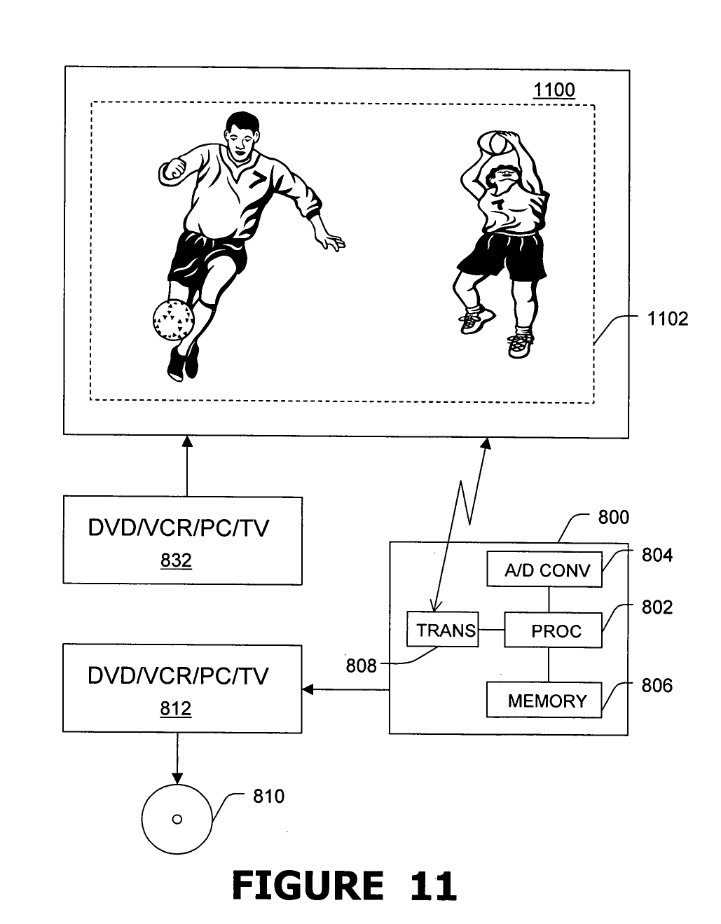

FIG. 11 illustrates a further configuration of the display screen 1100 in which the selected area 1102 encompasses the entire display screen. In this configuration, the capturing system 800 can transmit the information to the multimedia player 832 that the media contents data of the entire screen 1100 is desired. Thus, in this case, the capturing system 800 performs substantially the same function as a recording device for recording a show or an event displayed on the display screen 1100.

While specific embodiments of the invention have been illustrated and described, other embodiments and variations are possible. All these are intended to be encompassed by the following claims.

1. A media contents capturing system for capturing media contents from a display of a multimedia player, comprising:
a display area selection element to select an area of the display;
a transceiver in communication with the multimedia player to provide data commands for receiving media contents data of the area of display; and
a processor configured to send and receive data commands and media contents data from said transceiver.

2. The media contents capturing system of claim 1, wherein said processor operates to determine whether the received media contents data is digital or analog.

3. The media contents capturing system of claim 2, further comprising:
an A-to-D converter to receive analog media contents data from the transceiver and converter the analog media contents data to digital data.

4. The media contents capturing system of claim 1, further comprising:
a storage medium for storing the captured digital media contents data.

5. The media contents capturing system of claim 5, wherein said storage medium includes DVD.

6. The media contents capturing system of claim 1, wherein said display area selection element includes a motion-sensible remote control device.

7. The media contents capturing system of claim 1, wherein the data commands transmitted from said transceiver to said multimedia player includes a command to transmit media contents data from a portion of the display.

8. The media contents capturing system of claim 7, wherein the portion of the display includes an insert screen disposed within the display.

9. The media contents capturing system of claim 1, wherein said data commands transmitted from said transceiver to said multimedia player includes coordinates of the selected area of the display.

10. The media contents capturing system of claim 1, further comprising:
an optical capturing element to optically capture media contents data of the selected area of the display.

11. A method for capturing media contents from a display of a first multimedia player, comprising:
selecting an area of the display; and
providing data commands to the first multimedia player to receive media contents data of the selected area of display.

12. The method of claim 11, further comprising:
determining whether the received media contents data is digital or analog.

13. The method of claim 12, further comprising:
receiving analog media contents data and converting the analog media contents data to digital data.

14. The method of claim 11, further comprising:
storing the captured digital media contents data on a digital storage medium.

15. The method of claim 11, further comprising:
displaying the captured digital media contents data on a second multimedia player.

16. The method of claim 11, wherein said selecting an area of the display includes using a motion-sensible remote control device to encompass the area to be captured

17. The method of claim 11, wherein said providing the data commands includes providing a command to transmit media contents data from a portion of the display.

18. The method of claim 17, wherein said providing a command includes a command to select an insert screen disposed within the display.

19. The method of claim 11, wherein said providing the data commands includes transmitting coordinates of the selected area of the display.

20. The method of claim 11, further comprising:
optically capturing media contents data of the selected area of the display.
